(19) United States
(12) Patent Application Publication
(10) Pub. No.: US 2021/0363694 A1
(43) Pub. Date: Nov. 25, 2021

(54) FABRIC COATING COMPOSITIONS

(71) Applicant: Hewlett-Packard Development Company, L.P., Spring, TX (US)

(72) Inventors: Xiaoqi Zhou, San Diego, CA (US); Zhang-Lin Zhou, San Diego, CA (US); Or Brandstein, San Diego, CA (US)

(73) Assignee: Hewlett-Packard Development Company, L.P., Spring, TX (US)

(21) Appl. No.: 17/058,682

(22) PCT Filed: Dec. 18, 2018
(86) PCT No.: PCT/US2018/066176

§ 371 Date: Nov. 25, 2020

(51) Int. Cl. D06P 5/30; C09D 11/322; D06P 1/54; D06P 1/642; D06P 1/52

(52) U.S. Cl. CPC D06P 5/30; C09D 11/322; D06P 1/5278; D06P 1/6424; D06P 1/54

(57) ABSTRACT

A fabric coating composition can include from 40 wt % to 90 wt % aqueous liquid vehicle, from 5 wt % to 50 wt % crosslinking polymer including a plurality of imine-type groups; and from 5 wt % to 50 wt % cationic polymer.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new print media, for example.

### BRIEF DESCRIPTION OF DRAWINGS

FIG. 1 schematically depicts an example coating composition for coating print media substrates in accordance with the present disclosure;

FIG. 2 schematically depicts an example coated print media in accordance with the present disclosure;

FIG. 3 provides a flow diagram for an example method of making coated print media in accordance with the present disclosure;

FIG. 4 depicts various chemical example reactions schemes for polycarbodiimide crosslinking that can occur in accordance with the present disclosure; and

FIG. 5 depicts various example crosslinking that can occur between example components of a coated fabric print medium and/or ink composition in accordance with the present disclosure.

### DETAILED DESCRIPTION

The present disclosure is drawn to fabric coating compositions, coated fabric print media, and methods of textile printing. The fabric coating composition (and dry coating layer formed therefrom) include multiple components, namely a crosslinking polymer with multiple imine groups or multiple carbodiimide groups, and a cationic polymer, such as a quaternary amine, with multiple groups that are reactive with the imine and/or carbodiimide groups to become crosslinked by the crosslinking polymer. The cationic polymer can assist with fabric printing due to the nature of the cationic nature of the polymer (contributing to ink composition fixation, for example), as well as due to crosslinkable groups that can react with the C═N or N═C═N groups of the crosslinking polymer (contributing to good durability, for example). The crosslinkable groups can also enhance durability by crosslinking with polymer binder that may be present in ink compositions printed thereon as well as by crosslinking with the fabric substrate, for example.

In one example, a fabric coating composition includes from 40 wt % to 90 wt % aqueous liquid vehicle, from 5 wt % to 50 wt % crosslinking polymer including a plurality of imine-type groups, and from 5 wt % to 50 wt % cationic polymer. In one example, the crosslinking polymer and the cationic polymer can be present in the fabric coating composition at a weight ratio of 2:1 to 1:10. In another example, the crosslinking polymer can include a polyimine including multiple imine groups, wherein the polyimine has a weight average molecular weight of from 1,000 Mw to 100,000 Mw. In another example, the crosslinking polymer can include a polycarbodiimide having multiple carbodiimide groups and having a weight average molecular weight of from 1,000 Mw to 100,000 Mw. The cationic polymer can be, for example, a quaternary amine-containing polymer having a weight average molecular weight of from 1,000 Mw to 100,000 Mw.

In another example, a coated fabric print medium includes a fabric substrate, and a coating layer on the fabric substrate having a 0.5 gsm to 10 gsm dry coating weight basis. In this example, the coating layer includes rom 10 wt % to 90 wt % crosslinking polymer including a plurality of imine-type groups, and from 10 wt % to 90 wt % cationic polymer. The crosslinking polymer can be a polyimine, a polycarbodiimide, a mixture of the polyimine and the polycarbodiimides, or a polymer that is both a polyimine and a polycarbodiimide. The cationic polymer can include, for example, a cationic polyamine selected from diethylenetriamine, 1,5-diaminopentane, 1,5-diaminopentane dihydrochloride, tris(2-aminoethyl)amine, 1,4,7-triazacyclononane, N,N′-bis(3-aminopropyl)-1,4-butanediamine tetrahydrochloride, N, N′-bis(3-aminopropyl)ethylenediamine, N,N′-bis(2-aminoethyl)-1,3-propanediamine, or a combination thereof. Alternatively, the cationic polymer can include a cationic macromolecular polymer selected from polyacrylamide, polyethyleneimine, acrylamide-acrylic acid, N,N-dimethylaminoethyl methyl acrylate halide quaternary, N,N-dimethylaminoethyl methacrylate methyl halide (e.g., chloride) quaternary, dimethylamine-epichlorohydrin, monomethylamine-epichlorohydrin, polyamine-epichlorohydrin, polyethylenediamine, or a combination thereof. In one example, the cationic polymer can be a quaternary amine-containing polymer, such as an epichlorohydrin amine polymer, e.g., dimethylamine-epichlorohydrin copolymer; a polydiallyldimethylammonium polymer, e.g., polyDADMAC; or a combination thereof. In one more specific example, the cationic polymer can include a plurality of imine-crosslinkable groups separate from the cationic charge centers of the cationic polymer, wherein the imine-crosslinkable groups are selected from amine groups, carboxylic acid groups, hydroxyl groups, or a combination thereof.

In another example, a method of textile printing includes ejecting an ink composition onto a coated fabric print medium. The coated fabric print medium includes a fabric substrate, and a coating layer on the fabric substrate. The coated layer has a 0.5 gsm to 10 gsm dry coating weight basis, and includes from 10 wt % to 90 wt % crosslinking polymer including a plurality of imine-type groups, and from 10 wt % to 90 wt % cationic polymer. The ink composition includes water, organic co-solvent, pigment having dispersant associated with or attached thereto, and polymer binder particles. The method can further include crosslinking imine-crosslinkable groups from the polymer binder particles in the ink composition as well as imine-crosslinkable groups from the fabric substrate with a subset of the imine-type groups of the crosslinking polymer. With respect to the binder particles, in one example, the binder particles can include polyurethane particles including a polyurethane polymer with sulfonated- or carboxylated-alkyl diamine groups and isocyanate-generated amino groups. In another example, the binder particles can include latex particles including (meth)acrylic polymer having an acid number from 0 mg KOH/g to 60 mg KOH/g and a glass transition temperature from −30° C. to 50° C., e.g., styrene (meth)acrylic polymer. In another example, the binder particles can include hybrid particles including the polyurethane polymer and a (meth)acrylic polymer described above.

It is noted that when discussing the fabric coating compositions, the coated fabric print media, and methods, these discussions can be considered applicable to one another whether or not they are explicitly discussed in the context of that specific example. Thus, for example, when discussing a polycarbodiimide related to the fabric coating compositions, such disclosure is also relevant to and directly supported in the context of the coated fabric print media and methods, and vice versa, etc.

It is also understood that terms used herein will take on their ordinary meaning in the relevant technical field unless specified otherwise. In some instances, there are terms defined more specifically throughout the specification or included at the end of the present specification, and thus, these terms have a meaning as described herein.

The term “coating” and “coated” is used herein to describe the coating composition, or to describe a composition applied to a surface of a fabric substrate. However, it is noted that the terms “coating” or “coated” may or may not indicate the presence of a continuous layer of a composition applied on top of the fabric substrate as a discrete layer, but rather can more typically be similar in nature to a surface treatment that may penetrate the fabric substrate surface in some examples and/or alter the surface chemistry of the fabric substrate. Thus, the terms “coating” and “coated” should be interpreted to include compositions that modify the surface of the fabric substrate in some manner, either by a separate layer of material or by surface modification or treatment of the fabric substrate.

With respect to the cationic polymer, the term “imine-crosslinkable” group(s), such as used when referring to the polymer binder particles that may be present in an ink composition, the fabric substrate, or even the cationic polymer that is also present in the coating composition or coated fabric print medium, does not mean that the crosslinkable groups are imine groups or carbodiimide groups, but rather refers to a plurality of functional group types that are crosslinkable with the imine-type groups of the crosslinking polymer. Examples include carboxylic acid moieties, alcohol moieties, and/or amine moieties. In one example, a single structure (fabric) or polymer (binder and/or cationic polymer) can include one type of amine-crosslinkable group, e.g., carboxylic acid, alcohol, or a single type of amine. In another example, there can be multiple types of imine-crosslinkable groups, e.g., two or three of the carboxylic acid, alcohol, or types of amines.

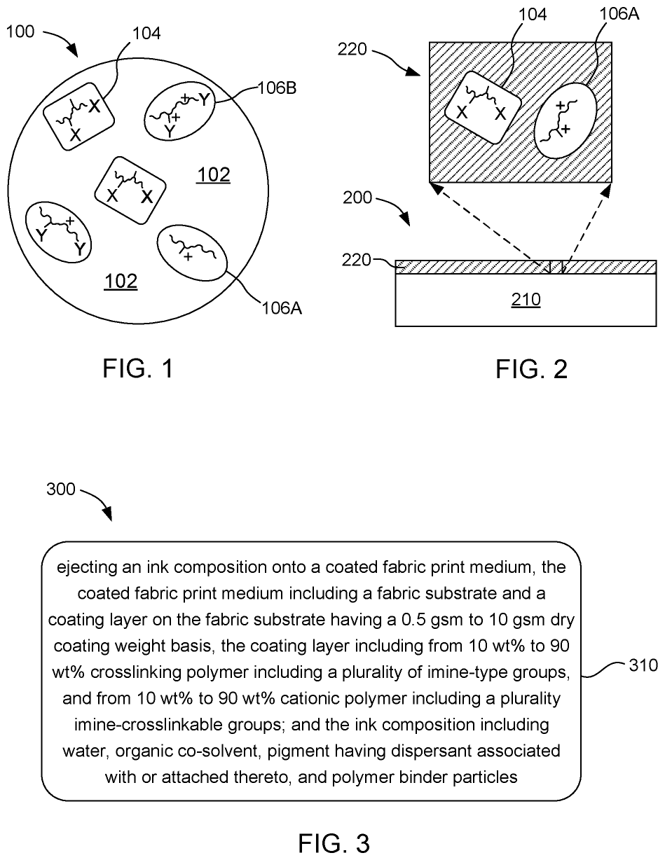

Turning now to more specific detail regarding the coating compositions, as shown in FIG. 1, an example fabric coating composition 100 can include an aqueous liquid vehicle 102, crosslinking polymer 104 including a plurality of imine-type groups shown at “X,” and cationic polymer 106A. In one specific example, the cationic polymer 106B can include imine-crosslinkable groups, such as those shown at “Y,” but in other examples, the durability can be provided by crosslinking with the fabric substrate and/or the polymer binder that may be present in an ink composition that may applied to the coated fabric print medium. The crosslinking polymer and the cationic polymer can be present in the fabric coating composition at a weight ratio of from 2:1 to 1:10, from 1:1 to 1:10, 2:1 to 1:10, 1:1 to 1:5, or 2:1 to 1:5, for example.

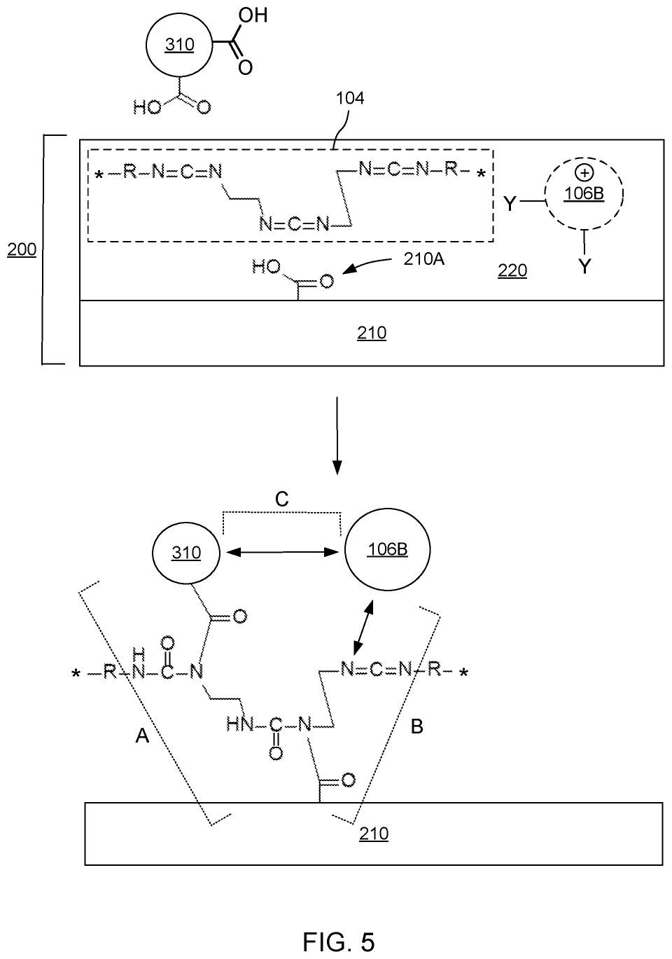

FIG. 2 provides an example coated fabric print medium 200 with the fabric coating composition of FIG. 1 at 100 having been applied to a fabric substrate 210 and dried, leaving the coating layer 220 thereon. The coating composition in this example includes the crosslinking polymer 104 including a plurality of imine-type groups shown at “X,” and cationic polymer 106A, which in some examples can include imine-crosslinkable groups (not shown in this example, but shown in FIGS. 1 and 5 at “Y”). In further detail, in the coating layer, the imine-type groups can be crosslinked (or crosslinkable) to imine-crosslinkable groups from a variety of sources, such as the fabric substrate, polymer binder particles found in an ink composition, or even the cationic polymer if there are imine-crosslinkable groups present. Likewise, the imine-type groups can be crosslinked (or crosslinkable) to the fabric substrate. In still further detail, imine-type groups can remain available for crosslinking with an ink that may be printed thereon in a subsequent printing use, particularly if the ink includes an imine-crosslinkable group, e.g., acrylic latex binder, polyurethane binder, etc.

FIG. 3 depicts a method 300 of textile printing, which includes ejecting 310 an ink composition onto a coated fabric print medium. The coated fabric print medium includes a fabric substrate, and a coating layer on the fabric substrate. The coated layer has a 0.5 gsm to 10 gsm dry coating weight basis, and includes from 10 wt % to 90 wt % crosslinking polymer including a plurality of imine-type groups, and from 10 wt % to 90 wt % cationic polymer. The ink composition includes water, organic co-solvent, pigment having dispersant associated with or attached thereto, and polymer binder particles. The method can further include crosslinking imine-crosslinkable groups from the polymer binder particles in the ink composition as well as imine-crosslinkable groups from the fabric substrate with a subset of the imine-type groups of the crosslinking polymer.

As used herein, “ejecting” includes technologies where ink compositions or other fluids are ejected from jetting architecture, such as inkjet architecture. Inkjet architecture can include thermal or piezo inkjet pens. Additionally, such architecture can be configured to print varying drop sizes such as less than 10 nanograms (ng), less than 20 ng, less than 30 ng, less than 40 ng, less than 50 ng, etc. These upper limits can, in one example, also provide the upper limit of various ranges, where 1 ng or 2 ng can represent the lower end of the various range.

Turning now more specifically to the crosslinking polymer, as mentioned, the polymer can include multiple imine-type groups, such as imine group(s), carbodiimide group(s), or a combination thereof. As an initial point of clarification, when referring to the “imine-type group(s)” of the crosslinking polymer, this can include groups based on nitrogen double bonded to carbon without other heteroatoms directly bonded to the nitrogen or the carbon, e.g., imine (N═C) or carbodiimide (N═C═N). Other heteroatoms can be part of the crosslinking polymer, but there would be a carbon on either side of the imine-type group. A polycarbodiimide, for example, is considered to include imine-type groups because it has multiple carbodiimide moieties, which includes nitrogen double-bonded to carbon (and the carbon is further double-bonded to another nitrogen (N═C═N)). As there is no heteroatom present as part of this crosslinking group, it is considered to be an imine-type group. For contrast, a polyisocyanate group would not be considered to be an imine-type group because of the presence of the other type of heteroatom that is present, e.g., oxygen (N═C═O). Thus, the term “imine-type group” should be interpreted to mean any crosslinking polymer that is based on nitrogen double-bonded to a carbon with no other type of heteroatom (e.g., oxygen, sulfur, etc.) being bonded immediately adjacent to any N═C moiety of the imine-type group.

In further detail, when referring to crosslinking polymers with “a plurality of imine-type groups,” this can include “polyimines” indicating the presence of multiple imine (N═C) groups, “polycarbodiimides” indicating the presence of multiple carbodiimide (N═C═N) groups, and/or crosslinking polymers with both imine groups and carbodiimide groups. As a note, a crosslinking polymer with one imine group and one carbodiimide group is neither a polyimine nor a polycarbodiimide, but would still be considered to include a plurality of imine-type groups. Furthermore, a crosslinking polymer with multiple imine groups and multiple carbodiimide groups is considered to be a polyimine and a polycarbodiimide.

The crosslinking polymer, for example, can have a weight average molecular weight of from 1,000 Mw to 100,000 Mw, from 1,000 Mw to 75,000 Mw, from 1,000 Mw to 50,000 Mw, from 2,000 Mw to 100,000 Mw, from 2,000 Mw to 50,000 Mw, from 5,000 Mw to 100,000 Mw, from 5,000 Mw to 50,000 Mw, from 5,000 Mw 40,000 Mw, from 5,000 Mw to 30,000 Mw, or from 5,000 Mw to 20,000 Mw, for example. This is the case for both polyimines, polycarbodiimides, and polymers with both imine and carbodiimide groups. These crosslinking polymers can be aliphatic and/or aromatic polymers, and can include heteroatoms that do not impact the nature of multiple imine-type groups of the polymer, as outlined previously.

A The general structure for a polyimine is shown below in Formula I, as follows:

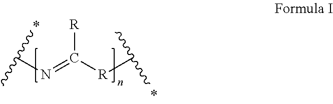

where individual R groups along the crosslinking polymer chain independently includes C1 to C15 alkyl, C3 to C15 alicyclic, C5 to C15 aromatic, heteroatom substitutes thereof, or a combination thereof. A “heteroatom” is defined herein as nitrogen, oxygen, and/or sulfur. A heteroatom substitute, if present, is not directly attached to the nitrogen or the carbon of the imine group. The balance of the crosslinking polymer notated by an asterisk (*) indicates a continuation of the crosslinking polymer. The crosslinking polymer may include other groups not specifically indicated in Formula I, such as urethane groups, carbodiimide groups, etc. The variable “n” in this example is an integer from 2 to 1,000, from 4 to 500, or from 10 to 250, for example. Furthermore, Formula I does not infer that the imide group and other constituents between the brackets repeats consecutively, as there is typically a carbon atom on either side of the bracketed group shown. Formula I also does not infer that the R groups would be identical to one another within one polymeric unit within the bracket, nor does it infer that the R groups would be identical at the various polymeric units along the polymer chain, though they may be in one example.

A The general structure for a polycarbodiimide is shown below in Formula II, as follows:

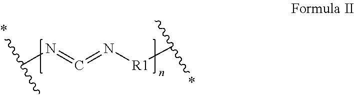

wherein R along the crosslinking polymer chain independently includes C1 to C15 alkyl, C3 to C15 alicyclic, C5 to C15 aromatic, heteroatom substitutes thereof, or a combination thereof. A heteroatom substitute, if present, is not directly attached to the nitrogen or the carbon of the imine group. The balance of the crosslinking polymer notated by an asterisk (*) indicates a continuation of the crosslinking polymer. The crosslinking polymer may include other groups not specifically indicated in Formula II, such as urethane groups, carbodiimide groups, etc. The variable “n” in this example is an integer from 2 to 1,000, from 4 to 500, or from 10 to 250, for example. Furthermore, Formula II does not infer that the imide group and other constituents between the brackets repeats consecutively, as there is typically a carbon atom on either side of the bracketed group shown. Formula II also does not infer that the R groups would be identical to one another within one polymeric unit within the bracket, nor does it infer that the R groups would be identical at the various polymeric units along the polymer chain, though they may be in one example.

The polyimine or the polycarbodiimide can, as mentioned, include other components or even other polymer types copolymerized therewith. For example, the polyimines and/or polycarbodiimides can include urethane caps and/or polyurethane portions. Two more specific example structures for a polyimine-polyurethane hybrid and a polycarbodiimide-polyurethane hybrid are shown in Formula III and in Formula IV, respectively, as follows:

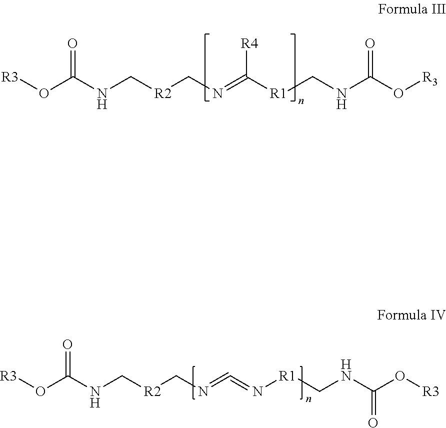

wherein R1-R4 along the crosslinking polymer chain independently be or include C1 to C15 alkyl, C3 to C15 alicyclic, C5 to C15 aromatic, heteroatom substitutes thereof, or a combination thereof. Furthermore, R2-R4 can also independently be or include a urethane group and/or a carbodiimide group, or even a polyurethane oligomer or polymer. The variable “n” in this example is an integer from 2 to 1,000, from 4 to 500, or from 10 to 250, for example.

Considering in further detail polycarbodiimides in particular as an example, as mentioned, these crosslinking polymers include multiple carbodiimide reactive groups, e.g., an average of 2 or more carbodiimide groups. However, as mentioned, they can also be combined with other functional reactive groups. Thus, there are multifunctional water-dispersible polycarbodiimides that provide high levels of crosslinking.

Non-limiting examples of polycarbodiimides that can be used for the crosslinking polymer include Carbodilite® polymers from Nasshinbo (Japan), such as Carbodilite® SV-02, V-02, V-02-L2, and/or E-02. Particularly, Carbodilite® SV-02 polycarbodiimides can be selected for use because it is water based, and is free of volatile organic cosolvent (VOC free). It is considered to be non-toxic and can assist with waterborne resins various attributes such as water, solvent, and chemical resistance. It can also improve hardness, abrasion, scratch resistance, etc. Carbodilite® SV-02 reacts with carboxyl groups even at room temperature with dosages as low as about 7 wt % or even as low in some situations as about 3 wt %. It also has good alkali resistance, a long pot life, and good dispersibility in aqueous vehicles. Other examples of polycarbodiimides that can be used include Picassian® polymers from Stahl Polymers (USA), such as Picassian® XL-702 and Picassian® XL-732.

Polyimine and polycarbodiimide crosslinkers can provide good chemical resistances and physical properties to coatings made from aqueous resins like polyurethanes or polyacrylics, and in accordance with the present disclosure, by including a cationic polymer in fabric coatings as described herein, good durability and ink fixative properties can be obtainable.

Turning now to the cationic polymers of the present disclosure, cationic polymers can provide multiple cationic charge centers for ink fixation, for example, and the cationic polymers can also include imine-crosslinkable groups to interact with the polyimines of the crosslinking polymers described herein. Example cationic polymers that can be used include polyamine selected from diethylenetriamine, 1,5-diaminopentane, 1,5-diaminopentane dihydrochloride, tris(2-aminoethyl)amine, 1,4,7-triazacyclononane, N,N′-bis(3-aminopropyl)-1,4-butanediamine tetrahydrochloride, N,N′-bis(3-aminopropyl)ethylenediamine, N,N′-bis(2-aminoethyl)-1,3-propanediamine, or a combination thereof. Alternatively, the cationic polymer can include a cationic macromolecular polymer selected from polyacrylamide, polyethyleneimine, acrylamide-acrylic acid, N,N-dimethylaminoethyl methyl acrylate halide quaternary, N,N-dimethylaminoethyl methacrylate methyl halide (e.g., chloride) quaternary, dimethylamine-epichlorohydrin, monomethylamine-epichlorohydrin, polyamine-epichlorohydrin, polyethylenediamine, or a combination thereof.

In one specific example, the cationic polymer can be a quaternary amine-containing polymer, such as an epichlorohydrin amine polymer, e.g., dimethylamine-epichlorohydrin copolymer; a polydiallyldimethylammonium polymer, e.g., polyDADMAC; or a combination thereof. For example, the quaternary amine-containing polymer can include a dimethylamine-epichlorohydrin copolymer having the structure of Formula V, or can include a polydiallyldimethylammonium, e.g., polyDADMAC as a chloride salt, having the structure of Formula VI, as follows:

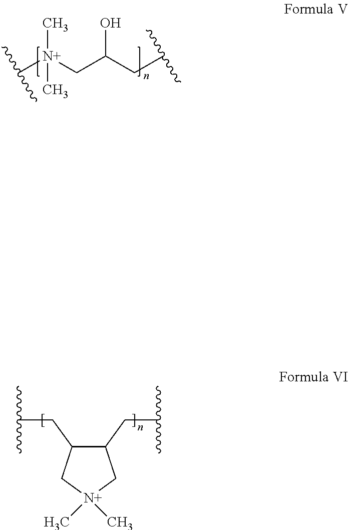

where n is from 10 to 1,500, or can be from 15 to 500, from 20 to 400, from 20 to 250, or from 25 to 200 for in both examples, namely Formula V and Formula VI.

In another example, the cationic polymer can have cationic groups as part of the main chain (polymer backbone) or as part of an appended side-chain (pendent group). In one example, the cationic polymer can be a naturally occurring polymer such as cationic gelatin, cationic dextran, cationic chitosan, cationic cellulose, cationic cyclodextrin, etc. The cationic polymer can also be a synthetically modified naturally occurring polymer such as a modified chitosan, e.g., carboxymethyl chitosan, N, N, N-trimethyl chitosan chloride, etc. In one specific example, the cationic polymer can be a polymer having cationic groups as part of the main chain, such as an alkoxylated quaternary polyamine having the structure of Formula VII, as follows:

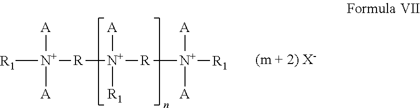

where R, R₁ and A can be the same group or different groups, such as linear or branched C₂-C₁₂ alkylene, C₃-C₁₂ hydroxyalkylene, C₄-C₁₂ dihydroxyalkylene, or dialkylarylene; X can be any suitable counter ion, such as halogen, chloride, bromide, iodide, etc., or other similarly charged anions; and n can be from 1 to 200, 1 to 100, 2 to 200, 2 to 100, 5 to 200, 5 to 100, 10 to 200, 10 to 100, 10 to 50, or 50 to 200, for example. In this example, the nitrogen atoms along the backbone can be quaternized.

In another example, an ionene polymer can used, which is a polymer having ionic groups that are appended to the backbone unit as a side-chain, with an example including quaternized poly(4-vinyl pyridine), having the structure of Formula VIII, as follows:

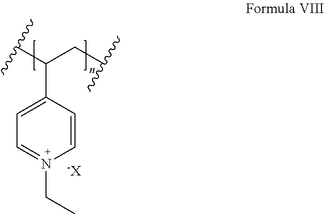

Again, in this example, X can be any suitable counter ion, such as halogen, chloride, bromide, iodide, etc., or other similarly charged anions; and n can be from 1 to 200, 1 to 100, 2 to 200, 2 to 100, 5 to 200, 5 to 100, 10 to 200, 10 to 100, 10 to 50, or 50 to 200, for example. Here, the quaternary amine is present on a side-chain rather than on the backbone of the polymer.

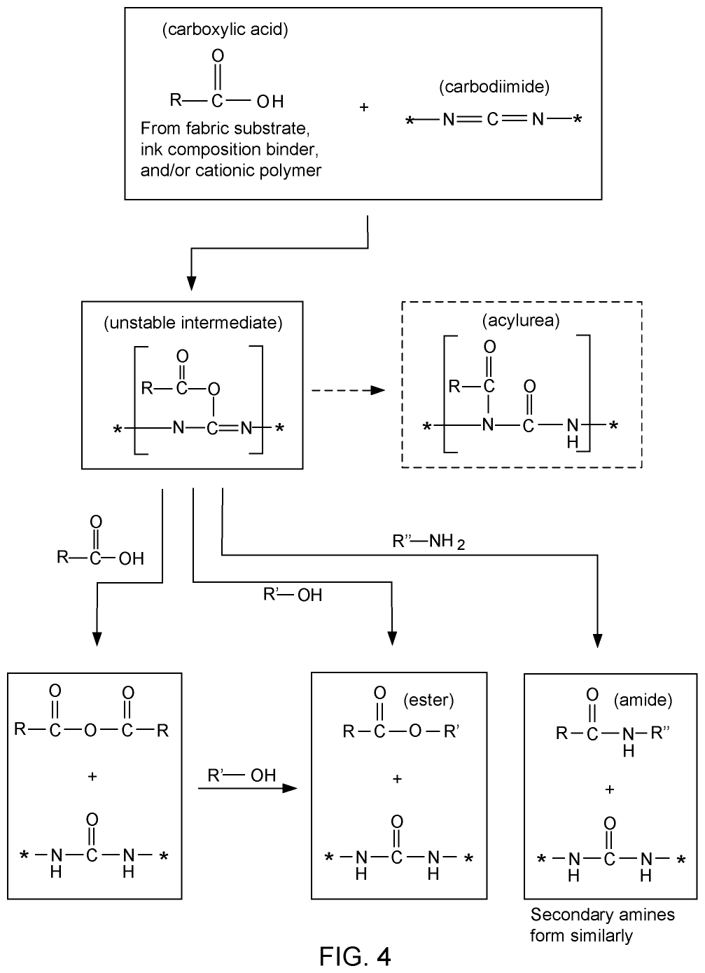

As mentioned, the cationic polymer, in addition to the cationic charge centers, can include a plurality of imine-crosslinkable groups, such as amine groups, carboxylic acid groups, hydroxyl groups, etc., as shown and described in greater detail in FIGS. 4 and 5 hereinafter.

The cationic polymer can be, for example, any cationic polymer with imine-crosslinkable groups, and can have a weight average molecular weight of from 1,000 Mw to 100,000 Mw, from 1,000 Mw to 75,000 Mw, from 1,000 Mw to 50,000 Mw, from 2,000 Mw to 100,000 Mw, from 2,000 Mw to 50,000 Mw, from 5,000 Mw to 100,000 Mw, from 5,000 Mw to 50,000 Mw, from 5,000 Mw 40,000 Mw, from 5,000 Mw to 30,000 Mw, or from 5,000 Mw to 20,000 Mw, for example.

The chemistry of polycarbodiimide crosslinking is shown by way of example in FIG. 4. To illustrate, the reaction of a carbodiimide group of a polycarbodiimide crosslinking polymer with a carboxylic acids (—COOH) can result in an unstable intermediate, which can form a more stable acylurea. However, by reacting the intermediate with a compound including carboxylic acid groups, hydroxyl groups, or amine groups, for example, further reaction can result in ester or amide linkages. R, R′, and R″ are shown primarily to track the R groups from one compound to the next, so are not particularly limiting in the context of FIG. 4. However, by way of example, R, R′, and/or R″ represents any organic group that may be present where indicated, including carbodiimide groups or urethane groups, or other constituents such as alkyl groups, alicyclic groups, aromatic groups, heteroatom substitutes thereof, or a combination thereof. It is not the purpose of FIG. 4 to limit the number or type of R groups that can be present, but rather to show the functional portions of the various polymers for purposes of understanding example reactions. Furthermore, FIG. 4 is intended to be inclusive of various types of crosslinking mechanism, but there can be others as well, depending on the compounds that may be present in a specific system.

In further detail with respect to the crosslinking for the polycarbodiimide, it is notable that the carboxylic acids, alcohols, and/or amines can be provided for crosslinking by multiple sources, such as the fabric substrate, a component of the ink composition that may be printed thereon, e.g., polyurethane binder, acrylic latex polymers, or the like, and/or the imine-crosslinkable groups of the cationic polymer that is also included in the coating composition and coated fabric print medium of the present disclosure. These three sources of imine-crosslinkable groups (crosslinkable with imines and/or carbodiimide groups) can provide a variety of crosslinking at the fabric print medium, which can enhance durability and ink fixation, for example.

FIG. 5 provides examples of crosslinking that can occur between various components of a coated fabric print medium 200. The coated fabric print medium, as mentioned, includes a fabric substrate 210 (carboxylic acid groups of the fabric substrate are also shown and labeled as part of the fabric substrate at 210A) and a coating layer 220 thereon. The coating layer includes a crosslinking polymer 104, which in this example is a polycarbodiimide crosslinking polymer. R represents any organic group that may be present on the polycarbodiimide, including additional carbodiimide groups or urethane groups, or other constituents such as alkyl groups, alicyclic groups, aromatic groups, heteroatom substitutes thereof, a combination thereof. It is not the purpose of FIG. 5 to limit the number or type of R groups that can be present, but rather to show the functional portions of the various polymers or other substrates that can interact in crosslinking. The coating composition in this example includes the crosslinking polymer 104 including a plurality of imine-type groups, which are polycarbodiimides in this example, and cationic polymer 106B, which in this example includes imine-crosslinkable groups, shown at “Y.” Also shown in this example is an ink composition binder particle 310 that may be present within a printed ink composition. In this example, the ink composition binder particle may be an acrylic latex particle with surface hydroxyl group, but could be a polyurethane as well with another type of imine-crosslinkable groups as the surface. Thus, in the coating layer, the imine-type groups can be crosslinked to the imine-crosslinkable groups from one or more of a few sources. For example, multiple carbodiimide groups of the polycarbodiimide can crosslink the fabric substrate to the ink composition binder particle, shown at “A,” crosslink the fabric substrate to the cationic polymer, shown at “B,” and/or crosslink the ink composition binder to the cationic polymer, shown at “C.” Arrows are used to schematically show some of the linkages, while some of the other linkages show example chemistry. More detail regarding these and other linkages can be seen in FIG. 4, and as described herein is some detail.

In addition to the crosslinking polymer and the cationic polymer, the coating compositions and coatings present on the fabric substrates can include particulate filler(s), or in other examples, may not include particulate filler. Examples can include inorganic pigment(s), such as white inorganic pigments if the media is intended to be white, for example. Examples of inorganic pigments that may be used include, but are not limited to, aluminum silicate, kaolin clay, a calcium carbonate, silica, alumina, boehmite, mica and talc, and combinations or mixtures thereof. In some examples, the inorganic pigment includes a clay or a clay mixture. In some examples, the inorganic pigment includes a calcium carbonate or a calcium carbonate mixture. The calcium carbonate may be one or more of ground calcium carbonate (GCC), precipitated calcium carbonate (PCC), modified GCC, and modified PCC, for example. For example, the inorganic pigment may include a mixture of a calcium carbonate and a clay. The particulate fillers can have average particle size ranged from 0.1 micro to 20 micro, with a dry weight ratio of total polymer content to particles to particulate filler ranging from 10 to 1, from 1 to 10, from 4 to 1, or from 1 to 4, for example.

When applying the coating composition to a fabric substrate, the coating composition can be applied to any media substrate type using any method appropriate for the coating application properties, e.g., grams per square meter (gsm), viscosity, etc. Application of the coating composition to the fabric substrate can be at from 0.5 gsm to 10 gsm, from 0.5 gsm to 8 gsm, or from 1 gsm to 8 gsm, from 1 gsm to 5 gsm, without being limiting. The viscosity of the coating composition, for example, can be similar to that of water or slightly higher if applied as a solution using a sprayer, e.g., about 1 centipoise (cps) to about 100 cps or about 2 cps to about 50 cps at 20° C., or it can have a higher viscosity in some examples, e.g., from about 100 cps to about 1,000 cps or from about 200 cps to 1,000 cps at 20° C. Other non-limiting examples of coating methods include padder size press, slot die, blade coating, and Meyer rod coating, dip coating, etc. In one example, any of a variety of spray coating methods may be used with the present embodiment. In one example, the fabric substrate can be passed under an adjustable spray nozzle. The adjustable spray nozzle may be configured to alter the rate at which the pre-treatment solution is sprayed onto the fabric substrate. By adjusting factors such as the rate at which the fabric substrate is passed under the nozzle, the rate at which the composite solution is sprayed on the fabric, the distance of the fabric substrate from the nozzle, the spraying profile of the nozzle, and/or the concentration of the pre-treatment solution, a coating composition may be applied for any of a number of applications.

Furthermore, the application of the coating composition can be carried out using padding procedures. The fabric substrate can be soaked in a bath and the excess can be rolled out. More specifically, impregnated fabric substrates (prepared by bath, spraying, dipping, etc.) can be passed through padding nip rolls under pressure. The impregnated fabric, after nip rolling, can then be dried under heat at any functional time which is controlled by machine speed with peak fabric web temperature. In some examples, pressure can be applied to the fabric substrate after impregnating the fabric base substrate with the pre-treatment composition. In some other examples, the surface treatment is accomplished in a pressure padding operation. During such operation, the fabric base substrate is firstly dipped into a pan containing treatment coating composition and is then passed through the gap of padding rolls. The padding rolls (a pair of two soft rubber rolls or a metal chromic metal hard roll and a tough-rubber synthetic soft roll for instance), apply the pressure to composite-wetted textile material so that composite amount can be accurately controlled. In some examples, the pressure that is applied can be from 10 PSI to 150 PSI or, in some other examples, can be from 30 PSI to 70 PSI.

The composition can be dried using box hot air dryer or another drying methodology. The dryer can be a single unit or could be in a serial of 3 to 7 units so that a temperature profile can be created with initial higher temperature (to remove excessive water) and mild temperature in end units (to ensure completely drying with a final moisture level of less than 1-5% for example). The dryer temperature can be programmed into a profile with higher temperature at the beginning of the drying when wet moisture is higher, and then reduced to lower temperature as the coating composition becomes drier, though other drying profiles can likewise be used. The dryer temperature can be controlled to a temperature of less than about 100° C. in one example, and in other examples, the operation speed of the padding/drying line can be from 10 yards/minute to 100 yards/minute, though speeds outside of this range can also be used.

Thus, textiles and fabrics can be treated with the coating compositions of the present disclosure, including cotton fibers, treated and untreated cotton substrates, polyester substrates, nylons, silk, blended substrates thereof, etc. It is notable that the term “fabric substrate” or “fabric media substrate” does not include materials such as any paper (even though paper can include multiple types of natural and synthetic fibers or mixtures of both types of fibers). Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

Thus, the fabric substrate can include natural fiber and synthetic fiber, e.g., cotton/polyester blend. The amount of the various individual fiber types can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

The fabric substrate can have a basis weight ranging from 10 grams per square meter (gsm) to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). By measuring OD and/or L*a*b* both before and after washing, ΔOD and ΔE value can be determined, which can be a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modified to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (RT) to deal with the problematic blue region at hue angles of about 275°), ii) compensation for neutral colors or the primed values in the L*C*h differences, iii) compensation for lightness (S_{L}), iv) compensation for chroma (S_{C}), and v) compensation for hue (SH). The 2000 modification can be referred to herein as “ΔE₂₀₀₀.” In accordance with examples of the present disclosure, ΔE value can be determined using the CIE definition established in 1976, 1994, and 2000 to demonstrate washfastness.

Ink compositions that can be printed on the coated fabric print media of the present disclosure can be pigmented ink with a binder polymer, such as latex binder particles, e.g., acrylic latex, or polyurethane particles. These solids can be carried by a liquid vehicle that includes water, organic cosolvent, and any of a number of other liquid ingredients, e.g., surfactant, biocide, sequestering agent, dispersing polymer, etc. The polymer binder particles can include, in some more specific examples, imine-crosslinkable groups that are available for reaction with the imine-type crosslinking groups of the crosslinking polymer (found in the coating or the coated fabric print medium, for example).

A wide variety of polyurethanes and/or latex polymers can be used for this purpose. The polyurethane may be aliphatic (straight-chained, branched, and/or alicyclic) or aromatic, or may be any of a variety of types of polyurethane, including polyester-type, Some specific examples of commercially available aliphatic waterborne polyurethanes include Sancure® 1514, Sancure® 1591, Sancure® 2260, and Sancure® 2026 (all of which are available from Lubrizol Inc.). Some specific examples of commercially available castor oil-based polyurethanes include Alberdingkusa® CUR 69, Alberdingkusa® CUR 99, and Alberdingkusa® CUR 991 (all from Alberdingk Boley Inc.). Other examples can include polyester-type polyurethanes that may be carboxylated and/or sulfonated. An example aliphatic polyester-polyurethane binder that can be used is Impranil® DLN-SD (Mw 133,000 Mw; Acid Number 5.2; Tg −47° C.; Melting Point 175-200° C.) or Impranil® DL 1380 from Covestro (Germany), and an example of an aromatic polyester-polyurethane binder that can be used is Dispercoll® U42. Example components used to prepare the Impranil® DLN-SD or other similar anionic aliphatic polyester-polyurethane binders can include pentyl glycols, e.g., neopentyl glycol; C₃ to C₅ alkyl dicarboxylic acids, e.g., adipic acid; C₄ to C₈ alkyl diisocyanates, e.g., hexamethylene diisocyanate (HDI or HMDI); diamine sulfonic acids, e.g., 1-[(2-aminoethyl)amino]-methanesulfonic acid or 2-[(2-aminoethyl)amino]-ethanesulfonic acid; etc. Example components used to prepare the Dispercoll® U42 or other similar aromatic polyester-polyurethane binders can include aromatic dicarboxylic acids, e.g., phthalic acid; C₄ to C₈ alkyl dialcohols, e.g., hexane-1,6-diol; C₄ to C₈ alkyl diisocyanates, e.g., hexamethylene diisocyanate (HDI); diamine sulfonic acids, e.g., 2-[(2-aminoethyl)amino]-methanesulfonic acid or 1-[(2-aminoethyl)amino]-ethanesulfonic acid; etc. Other types of polyurethanes can also be used, such as polyether-type polyurethane, polycarbonate ester-polyether-type polyurethane, and/or polycarbonate-type polyurethane.

Other examples of the polyurethane polymeric compound that can be used include vinyl-urethane, acrylic urethane, polyurethane-acrylic, polyether polyurethane, polyester polyurethane, polycaprolactam polyurethane, or polyether polyurethane. Any of these examples may be aliphatic or aromatic. For example, the polyurethane may include aromatic polyether polyurethanes, aliphatic polyether polyurethanes, aromatic polyester polyurethanes, aliphatic polyester polyurethanes, aromatic polycaprolactam polyurethanes, or aliphatic polycaprolactam polyurethanes.

In another example, the polymer binder particles can be a latex polymer, such as a (meth)acrylic polymers, otherwise referred to as poly(meth)acrylate-based polymer or poly(meth)acrylates. Examples of poly(meth)acrylates include polymers made by hydrophobic addition monomers, such as C1-C12 alkyl acrylates, carboxylic containing monomers (e.g., acrylic acid, methacrylic acid), vinyl ester monomers (e.g., vinyl acetate, vinyl propionate, vinyl benzoate, vinyl pivalate, vinyl-2-ethylhexanoate, vinyl versatate, etc.), vinyl benzene monomer, C1-C12 alkyl acrylamide and methacrylamide (e.g., t-butyl acrylamide, sec-butyl acrylamide, N,N-dimethylacrylamide, etc.), crosslinking monomers (e.g., divinyl benzene, ethylene glycol dimethacrylate, bis(acryloylamido)methylene, etc.), and combinations thereof. As specific examples, polymers made from the polymerization and/or copolymerization of alkyl acrylate, alkyl methacrylate, and/or vinyl esters may be used. Any of the listed monomers (e.g., hydrophobic addition monomers, aromatic monomers, etc.) may be copolymerized with styrene or a styrene derivative. As specific examples, polymers made from the copolymerization of alkyl acrylate, alkyl methacrylate, and/or vinyl esters, with styrene or styrene derivatives may also be useful. The latex polymer, for example, can have an acid number from 0 mg KOH/g to 60 mg KOH/g, from 0 mg KOH/g to 50 mg KOH/g, from 5 mg KOH/g to 60 mg KOH/g, from 5 mg KOH/g to 50 mg KOH/g, or from 10 mg KOH/g to 40 mg KOH/g. The latex polymer can also have a glass transition temperature from −30° C. to 50° C., from −30° C. to 35° C., from −30° C. to 15° C., from 0° C. to 50° C., from 0° C. to 35° C., or from ° C. to 15° C., for example,

In another example, the polymer binder particles can include hybrid particles of the polyurethane and the latex polymer, for example. For example, a polyurethane core and a latex shell can be prepared as a polyurethane-latex hybrid by copolymerizing the latex monomers, e.g., for a (meth)acrylic latex polymer or styrene (meth)acrylic latex polymer, in the presence of polyurethane particles. Surfactant can be used in some examples, but in other examples, surfactant can be omitted because the polyurethane can have properties that allow it to act as an emulsifier for the emulsion polymerization reaction. An initiator can be added to start the polymerization of the latex monomers, resulting in the polyurethane-latex hybrid particles.

The pigment in the ink composition can include pigment colorant, for example. In some examples, the pigment can be present in an amount from 0.5 wt % to 12 wt %, from 0.5 wt % to 10 wt %, from 1 wt % to 8 wt %, or from 2 wt % to 6 wt % in the ink composition. The pigment in the ink composition can be self-dispersed with a polymer, oligomer, or small molecule; or can be dispersed with a separate dispersant. Furthermore, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: Paliogen® Orange, Heliogen® Blue L 6901F, Heliogen® Blue NBD 7010, Heliogen® Blue K 7090, Heliogen® Blue L 7101F, Heliogen® Blue L 6470, Heliogen® Green K 8683, Heliogen® Green L 9140, Chromophtal® Yellow 3G, Chromophtal® Yellow GR, Chromophtal® Yellow 8G, Igrazin® Yellow SGT, and Igralite® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: Regal® 400R, Regal® 330R, Regal® 660R, Mogul® L, Black Pearls® L, MONARCH® 1400, Monarch® 1300, Monarch® 1100, Monarch® 1000, Monarch® 900, Monarch® 880, Monarch® 800, and Monarch® 700. The following pigments are available from Orion Engineered Carbons GMBH: Printex® U, Printex® V, Printex® 140U, Printex® 140V, Printex® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: Monastral® Magenta, Monastral® Scarlet, Monastral® Violet R, Monastral® Red B, and Monastral® Violet Maroon B. The following pigments are available from Clariant: Dalamar® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B. The following pigments are available from Sun Chemical: Quindo® Magenta, Indofast® Brilliant Scarlet, Quindo® Red R6700, Quindo® Red R6713, Indofast® Violet, L74-1357 Yellow, L75-1331 Yellow, L75-2577 Yellow, and LHD9303 Black. The following pigments are available from Birla Carbon: Raven® 7000, Raven® 5750, Raven® 5250, Raven® 5000 Ultra® II, RAVEN® 2000, Raven® 1500, Raven® 1250, Raven® 1200, Raven® 1190 Ultra®, Raven® 1170, Raven® 1255, Raven® 1080, and Raven® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, Cabojet® 250C cyan pigment dispersion from Cabot Corporation (USA), 17-SE-126 cyan pigment dispersion from Dom Pedro, HPF-M046 magenta pigment dispersion from DIC, Cabojet® 265M magenta pigment dispersion from Cabot, HPJ-Y001 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote π-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl 696 or Joncryl® ECO 675 (all available from BASF Corp., Germany).

In addition to the pigment, the polymer binder, the ink compositions described herein can also include an aqueous liquid vehicle to carry and provide jettability to the ink compositions, for example. In one example, the liquid vehicle can include water and an organic co-solvent. In a further example, the organic co-solvent can be present in an amount from 4 wt % to 49 wt %, or from 8 wt % to 25 wt % with respect to the total weight of the ink. In a still further example, the organic co-solvent can be present in an amount from 10 wt % to 15 wt %. In a particular example, the organic co-solvent can be 1,2-butanediol. In other examples, the organic co-solvent can include ethylene glycol, diethylene glycol, triethylene glycol, propylene glycol, dipropylene glycol, tripropylene glycol, 1,2-propanediol, 1,3-propanediol, 1,2-butanediol, 1,3-butanediol, 1,4-butanediol, 2,3-butanediol, 2-methyl-1,2-propanediol, 1,5-pentanediol, 2-methyl-2,3-butanediol, 1,6-hexanediol, 1,2-hexanediol, 2,5-hexanediol, 2-methyl-2,4-pentanediol, 2,3-dimethyl-2,3-butanediol, 2-ethyl-hexanediol, 1,2-octanediol, 1,2-decanediol, 2,2,4-trimethylpentanediol, 2-butyl-2-ethyl-1,3-propanediol, 2,2-diethyl-1,3-propanediol, glycerin, trimethylolpropane, pentaerythritol, and the like.

In certain examples, the ink composition can include a surfactant or a mixture of surfactants in a total amount from 0.05 wt % to 15 wt %, from 0.1 wt % to 10 wt %, from 0.3 wt % to 8 wt %, or from 0.5 wt % to 1.5 wt % with respect to the total weight of the ink. Suitable surfactants can include anionic, cationic, amphoteric and nonionic surfactants. Commercially-available surfactants or dispersants include the TAMOL™ series from Dow Chemical Co., nonyl and octyl phenol ethoxylates from Dow Chemical Co. (e.g., Triton™ X-45, Triton™ X-100, Triton™ X-114, Triton™ X-165, Triton™ X-305 and Triton™ X-405) and other suppliers (e.g., the T-DET™ N series from Harcros Chemicals), alkyl phenol ethoxylate (APE) replacements from Dow Chemical Co., Elementis Specialties, and others, various members of the Surfynol® series from Air Products and Chemicals, (e.g., Surfynol® 104, Surfynol® 104A, Surfynol® 104BC, Surfynol® 104DPM, Surfynol® 104E, Surfynol® 104H, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 82, Surfynol® CT-211, Surfynol® CT-221, Surfynol® OP-340, Surfynol® PSA204, Surfynol® PSA216, Surfynol® PSA336, Surfynol® SE and Surfynol® SE-F), Capstone® FS-35 from DuPont, various fluorocarbon surfactants from 3M, E.I. DuPont, and other suppliers, and phosphate esters from Ashland, Rhodia and other suppliers.

Various other additives can be included to provide desirable printability, shelf-life, image quality, etc., properties to the ink composition. Examples of these additives are those added to inhibit the growth of harmful microorganisms. These additives may be biocides, fungicides, and other microbial agents. Examples of suitable microbial agents include, but are not limited to, Nuosept® (Nudex, Inc.), Ucarcide™ (Union carbide Corp.), Vancide® (R.T. Vanderbilt Co.), Proxel® (ICI America), or a combination thereof.

Sequestering agents, such as EDTA (ethylene diamine tetra acetic acid), may be included to eliminate the deleterious effects of heavy metal impurities, and buffer solutions may be used to control the pH of the ink. From 0.01 wt % to 2 wt %, for example, can be used if present. Viscosity modifiers and buffers may also be present, as well as other additives to modify properties of the ink as desired. Such additives can be present at from 0.01 wt % to 20 wt % if present.

Anti-kogation agents can also be included in the ink composition. In some examples, anti-kogation agents can be included in an amount of 0.1 wt % to 10 wt % with respect to the total weight of the ink. In other examples, the anti-kogation agents can be included in an amount of 0.1 wt % to 3 wt %. Examples of anti-kogation agent include surfactants of the Crodafos® family available from Croda Inc. (Great Britain), such as Crodafos®N3A, Crodafos®N3E, Crodafos®N10A, Crodafos® HCE and Crodafos® SG. Other examples include Arlatone® Map 950 available from Croda Inc.; Monofax® 831, Monofax®1214 available from Mona Industries; Monalube® 215 and Atlox® DP13/6 available from Croda Inc.; and Liponic® EG-1 (LEG-1) available from Lipo Chemicals (USA).

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane disclosed herein. This value can be determined, in one example, by dissolving or dispersing a known quantity of a material in organic solvent and then titrating with a solution of potassium hydroxide (KOH) of known concentration for measurement.

The term “(meth)acrylate,” “(meth)acrylic,” or “(meth)acrylic acid,” or the like refers to monomers, copolymerized monomers, etc., that can either be acrylate or methacrylate (or a combination of both), or acrylic acid or methacrylic acid (or a combination of both). This can be the case for either dispersant polymer for a pigment dispersion or for dispersed polymer binder particles that may include co-polymerized acrylate and/or methacrylate monomers. Also, in some examples, the terms “(meth)acrylate” and “(meth)acrylic” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

As used herein, “liquid vehicle” or “ink vehicle” refers to a liquid fluid in which colorant, such as pigments, can be dispersed and otherwise placed to form an ink composition. A wide variety of liquid vehicles may be used with the systems and methods of the present disclosure. Such liquid vehicles may include a mixture of a variety of different agents, including, water, organic co-solvents, surfactants, anti-kogation agents, buffers, biocides, sequestering agents, viscosity modifiers, surface-active agents, water, etc.

As used herein, “pigment” generally includes pigment colorants.

As used herein, a plurality of items, structural elements, compositional elements, and/or materials may be presented in a common list for convenience. However, these lists should be construed as though individual members of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if the numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Preparation of Coating Compositions and Application to Fabric Substrates

Three (3) coating compositions (Coating 1, Coating 2, and Coating 3) were prepared in accordance with examples of the present disclosure to evaluate their durability and image properties on fabric substrates (printed with pigmented-inks with polyurethane binder) against a commercially available coating/pretreatment solution applied to fabric (Comparative 1—based on salts and polyacrylate chemistry) as well as with respect to untreated fabric (Comparative 2). The formulations for Coatings 1-3 are provided in Table 1, as follows:

TABLE 1

| | Coating 1 | Coating 2 | Coating 3 |
|---|---|---|---|
| | (dry parts | (dry parts | (dry parts |
| Ingredients | by Wt) | by Wt) | by Wt) |
| Floquat ™ 4820 | 50 | — | — |
| (cationic polymer) | | | |
| Floquat ™ 2250 | — | 50 | — |
| (cationic polymer) | | | |
| Floquat ™ 3150 | — | — | 50 |
| (cationic polymer) | | | |
| Carbodilite ® SV-02 | 50 | 50 | 50 |
| (crosslinker polymer) | | | |
| Sodium Hydroxide | Adjust | Adjust | Adjust |
| (pH control agent) | 7-7.5 pH | 7-7.5 pH | 7-7.5 pH |
| Dynwet ® 800 | 0.5 | 0.5 | 0.5 |
| (surfactant) | | | |
| [symbol] solids Content | 5% | 5% | 5% |

Floquat ™ is from SNF, Inc., (France).
Carbodilite ® is from Nasshinbo Chemical Co. (Japan).
Dynwet ® is from BYK-chemie, Gmbh (Germany)

Coating compositions 1-3 prepared in accordance with Table 1, as well as a commercially available treatment solution (Comparative 1; pre-treatment solution based on salt and polyacrylate) were applied to cotton fabric at a dry coat weight of 2 gsm. An uncoated sample of the cotton substrate was also retained as Comparative 2.

### Example 2—Ink Composition for Printing on Coated and Uncoated Fabric Substrates

Cyan and black ink compositions were prepared for evaluating the image quality and durability when printed on fabric substrates coated with a coating composition in accordance with the present disclosure. Specifically, the ink compositions were formulated as follows according to Table 2:

TABLE 2

| Ingredient | Category | Concentration (wt %) |
|---|---|---|
| Impranil ® DLN-SD | Polyurethane Binder | 6 |
| Glycerol | Organic Co-solvent | 6 |
| Crodafos ® N3 acid | Surfactant | 0.5 |
| LEG-1 | Organic Cosolvent | 1 |
| Acticide ® B20 | Biocide | 0.22 |
| Surfyno ®l 440 | Surfactant | 0.3 |
| Pigment | Colorant | Cyan (C) 3 or |
| | | Black (K) 2.5 |

Prints were generated by printing the ink compositions (black and cyan) on the coated fabrics as well as on samples of uncoated fabric using 3 dots per pixel (dpp) durability plots of ink composition using thermal inkjet pen A3410 pen, available from HP, Inc, (USA).

### Example 3—Optical Density (OD) and Washfastness Durability

After printing, the images on the coated fabric substrates were cured at 150° C. for 3 minutes. Wash durability evaluation was conducted using 5 washing machine cycles with a standard washing machine detergent, e.g., Tide, with the fabrics air-dried in between washes. The data is provided in Table 3. With respect to optical density, the higher the value, the higher the optical density value. After 5 washes, a change in OD can be used to determine fade, with lower values OD after 5 washes. ΔE values can be used to evaluate gamut reduction. (or a bigger differential between initial OD and indicating. Smaller values are better with respect to ΔE values.

TABLE 3

| | | | Black OD | Cyan OD | | |
|---|---|---|---|---|---|---|
| | Black | Cyan | after 5 | after 5 | ΔE | ΔE |
| Fabric ID | OD | OD | Washes | Washes | Black | Cyan |
| Coating 1 | 1.24 | 1.26 | 1.22 | 1.27 | 1.37 | 0.98 |
| Coating 2 | 1.23 | 1.23 | 1.20 | 1.17 | 0.89 | 2.07 |
| Coating 3 | 1.25 | 1.25 | 1.26 | 1.25 | 0.38 | 1.08 |
| Comparative 1 | 1.22 | 1.23 | 0.87 | 0.91 | 7.51 | 6.88 |
| (commercial | | | | | | |
| treatment) | | | | | | |
| Comparative 2 | 0.91 | 0.93 | 0.83 | 0.84 | 12.36 | 14.50 |
| (no treathment) | | | | | | |

As can be seen in Table 3, the coating compositions of the present disclosure provided increased black OD and color (cyan) OD right after printing in all but one instance (where the cyan OD was the same as Comparative 1). Furthermore, after 5 washes, Coatings 1-3 provided significantly better OD and ΔE color gamut retention than both Comparative 1 and Comparative 2. Even with initial high OD (which makes it more difficult to retain high OD and color gamut), the changes were minimal across the board for Coatings 1-3.

The present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A fabric coating composition, comprising:
from 40 wt % to 90 wt % aqueous liquid vehicle;
from 5 wt % to 50 wt % crosslinking polymer including a plurality of imine-type groups; and
from 5 wt % to 50 wt % cationic polymer.

2. The fabric coating of claim 1, wherein the crosslinking polymer and the cationic polymer are present in the fabric coating composition at a weight ratio of 2:1 to 1:10.

3. The fabric coating of claim 1, wherein the crosslinking polymer includes a polyimine including multiple imine groups, wherein the polyimine has a weight average molecular weight of from 1,000 Mw to 100,000 Mw.

4. The fabric coating of claim 1, wherein the crosslinking polymer includes a polycarbodiimide having multiple carbodiimide groups and having a weight average molecular weight of from 1,000 Mw to 100,000 Mw.

5. The fabric coating composition of claim 1, wherein cationic polymer is a quaternary amine-containing polymer having a weight average molecular weight of from 1,000 Mw to 50,000 Mw.

6. A coated fabric print medium, comprising:
a fabric substrate; and
a coating layer on the fabric substrate having a 0.5 gsm to 10 gsm dry coating weight basis, the coating layer including:
from 10 wt % to 90 wt % crosslinking polymer including a plurality of imine-type groups, and
from 10 wt % to 90 wt % cationic polymer.

7. The coated fabric print medium of claim 6, wherein the crosslinking polymer is a polyimine, a polycarbodiimide, a mixture of the polyimine and the polycarbodiimides, or a polymer that is both a polyimine and a polycarbodiimide.

8. The coated fabric print medium of claim 6, wherein the cationic polymer includes a cationic polyamine selected from diethylenetriamine, 1,5-diaminopentane, 1,5-diaminopentane dihydrochloride, tris(2-aminoethyl)amine, 1,4,7-triazacyclononane, N,N′-bis(3-aminopropyl)-1,4-butanediamine tetrahydrochloride, N, N′-bis(3-aminopropyl)ethylenediamine, N,N′-bis(2-aminoethyl)-1,3-propanediamine, or a combination thereof.

9. The coated fabric print medium of claim 6, wherein the cationic polymer includes a cationic macromolecular polymer selected from polyacrylamide, polyethyleneimine, acrylamide-acrylic acid, N,N-dimethylaminoethyl methyl acrylate halide quaternary, N,N-dimethylaminoethyl methacrylate methyl halide (e.g., chloride) quaternary, dimethylamine-epichlorohydrin, monomethylamine-epichlorohydrin, polyamine-epichlorohydrin, polyethylenediamine, or a combination thereof.

10. The coated fabric print medium of claim 6, wherein the cationic polymer is a quaternary amine-containing polymer.

11. The coated fabric print medium of claim 10, wherein the quaternary amine-containing polymer is an epichlorohydrin amine polymer, a polydiallyldimethylammonium polymer, or a combination thereof.

12. The coated fabric print medium of claim 6, wherein the cationic polymer further includes a plurality of imine-crosslinkable groups separate from cationic charge centers of the cationic polymer, wherein the imine-crosslinkable groups are selected from amine groups, carboxylic acid groups, hydroxyl groups, or a combination thereof.

13. A method of textile printing, comprising ejecting an ink composition onto a coated fabric print medium,
the coated fabric print medium, comprising:
a fabric substrate; and
a coating layer on the fabric substrate having a 0.5 gsm to 10 gsm dry coating weight basis, the coating layer including from 10 wt % to 90 wt % crosslinking polymer including a plurality of imine-type groups, and from 10 wt % to 90 wt % cationic polymer; and
the ink composition, comprising:
water,
organic co-solvent,
pigment having dispersant associated with or attached thereto, and
polymer binder particles.

14. The method of textile printing of claim 13, further comprising crosslinking imine-crosslinkable groups from the polymer binder particles in the ink composition as well as imine-crosslinkable groups from the fabric substrate with a subset of the imine-type groups of the crosslinking polymer.

15. The method of textile printing of claim 13, wherein the binder particles comprise:
polyurethane particles including a polyurethane polymer with sulfonated- or carboxylated-alkyl diamine groups and isocyanate-generated amino groups,
latex particles including (meth)acrylic polymer having an acid number from 0 mg KOH/g to 60 mg KOH/g and a glass transition temperature from −30° C. to 50° C., or
hybrid particles including the polyurethane polymer and a (meth)acrylic polymer.
